(19) United States
(12) Patent Application Publication
(10) Pub. No.: US 2025/0368867 A1
(43) Pub. Date: Dec. 4, 2025

(54) ADHESIVE COMPOSITION

(71) Applicant: DDP SPECIALTY ELECTRONIC MATERIALS US, LLC, Wilmington, DE (US)

(72) Inventors: Eric COLE, Auburn Hills, MI (US); Tyler AUVIL, Auburn Hills, MI (US)

(21) Appl. No.: 18/875,316

(22) PCT Filed: Jun. 2, 2023
(86) PCT No.: PCT/US2023/024269

§ 371 Date: Dec. 16, 2024

Related U.S. Application Data
(60) Provisional application No. 63/389,213, filed on Jul. 14, 2022.

(51) Int. Cl. C09J 151/08; C08K 3/22; C08K 5/14; C08K 5/17; C09J 9/00

(52) U.S. Cl. CPC C09J 151/08; C08K 3/22; C08K 5/14; C08K 5/17; C09J 9/00; C08K 2003/2227; C08K 2201/001

(57) ABSTRACT

Provided herein is a two-component, thermally-conductive acrylic-epoxy adhesive composition.

### FIELD OF INVENTION

The present invention relates to the field of epoxy-acrylic adhesive compositions.

### BACKGROUND OF THE INVENTION

There are many different design philosophies when assembling an electric vehicle battery pack. However, today, most are assembled in a modular fashion where multiple pack sub-assemblies, or modules, are constructed and placed into a pack. Each module will contain an array of battery cells, which are thermally connected via a thermal interface material (TIM) to some form of cooling unit with active liquid cooling (cooling channel, cold plate, etc.). The thermal connection between the cells and the cooling unit is critical to manage the heat that is generated during charging and discharging of the cells, which allows the cells to have greater performance efficiency and longevity.

Three different cell types are commonly used today: prismatic cells, pouch cells, and cylindrical cells. Prismatic cells and pouch cells often have a polymeric coating on the outside of the cell, which can facilitate bonding of the cells with a thermally-conductive adhesive. Such coatings allow for a wide range of chemistries to be used in bonding applications. Cylindrical cells, however, have a can (outer wall) that are often constructed using nickel-plated steel. Nickel is notoriously difficult to bond to for the following reasons: (1) nickel is an inherently inert material, which means that the surface energy is low compared to other metals, (2) nickel-plated surfaces have a low surface roughness and, (3) nickel-plating processes are known to provide surfaces with varying properties. Moreover, cylindrical cell designs may require adhesives with rapid cure speeds to reduce cycle times. Cycle time becomes especially important when the design utilizes an array of cells bonded to both the top and bottom of a single cold plate because the process will require that the adhesive has reached handling strength before flipping the cold plate.

Lastly, cylindrical cells are most commonly used because they have potential to be lower cost in the future due their potentially more streamlined manufacturing process. They are also often used in designs where engineers would like to use the mechanical rigidity of the cells, to impart rigidity into the vehicle structure. In this type of designs, a high strength/high modulus adhesive is ideal in helping transfer the rigidity of the cells to the vehicle structure.

When combined with thermally-conductive filler packages, polyurethanes, silicones, and epoxies could have some individual advantages in the assembly of cylindrical cell-based designs. However, such adhesives often cure slowly, and/or have poor adhesion to nickel-plated steel, particularly when they contain the high filler loadings that are required to make them thermally-conductive.

### SUMMARY OF THE INVENTION

In a first aspect, the invention provides a two-component, thermally-conductive epoxy-acrylic hybrid adhesive, comprising:
Part A
   ai) at least one methacrylate monomer;
   aii) at least one elastomeric toughener;
   aiii) a phosphorus-containing compound with mono-esters of phosphonic, mono- and di-esters of phosphonic and phosphoric acids having one unit of vinyl or allylic unsaturation present;
   aiv) a tertiary amine radical initiator;
   av) from 0.0025-0.065 wt % diethylhydroxylamine;
Part B
   bi) at least one epoxy resin;
   bii) an oxidizing agent;
wherein Part A and/or Part B comprise thermally-conductive filler such that when Part A and Part B are mixed together to form an adhesive mixture, the adhesive mixture comprises from 40-90 wt % thermally-conductive filler.

In a second aspect, the invention provides a method for adhering two or more substrates, comprising the steps:
(1) providing a two-component, thermally-conductive epoxy-acrylic hybrid adhesive, comprising:
Part A
   ai) at least one methacrylate monomer;
   aii) at least one elastomeric toughener;
   aiii) a phosphorus-containing compound with mono-esters of phosphonic, mono- and di-esters of phosphonic and phosphoric acids having one unit of vinyl or allylic unsaturation present;
   aiv) a tertiary amine radical initiator;
   av) from 0.0025-0.065 wt % diethylhydroxylamine;
Part B
   bi) at least one epoxy resin;
   bii) an oxidizing agent;
wherein Part A and/or Part B comprise thermally-conductive filler such that when Part A and Part B are mixed together to form an adhesive mixture, the adhesive mixture comprises from 40-90 wt % thermally-conductive filler;
(2) mixing Part A and Part B to obtain an adhesive mixture;
(3) applying the adhesive mixture to a first substrate, a second substrate or both;
(4) bringing the first substrate and the second substrate into adhesive contact; and
(5) allowing the adhesive mixture to cure.

### DETAILED DESCRIPTION OF THE INVENTION

The inventors have found that it is possible to achieve an epoxy-acrylic adhesive having good adhesion to nickel-plated steel, open times of greater than 16 minutes, and which are storage stable.

### Definitions and Abbreviations

THFMA tetrahydrofurfuryl methacrylate
CHMA cyclohexyl methacrylate
ATH aluminium trihydroxide
MAA methacrylic acid
HEMA Hydroxyethylmethacryl phosphate
SEC size exclusion chromatography
RH relative humidity
CF cohesive failure
AF adhesive failure

Equivalent and molecular weights are measured by gel permeation chromatography (GPC) using the method and equipment recited in the Examples section.

### At Least One Methacrylate Monomer (ai)

Part A of the adhesive comprises at least one methacrylate monomer. The methacrylate monomer is not particularly limited. Examples include monomers having the general structure of Formula I:

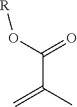

where R is an organic radical.

In preferred embodiments, R is selected from H, a C₁-C₁₈ substituted or unsubstituted cyclic or noncyclic aliphatic hydrocarbon radical, which may contain one or more heteroatoms, and a C₄-C₁₈ aromatic hydrocarbon radical, which may contain one or more heteroatoms.

More preferably, R is selected from a C₁-C₁₈ substituted or unsubstituted, cyclic or noncyclic aliphatic hydrocarbon radical, which may contain one or more heteroatoms, in particular R is cyclohexyl or CH₂-THF, where THE is a 2- or 3-tetrahydrofurfuryl radical.

Other examples of methacrylate monomers include isobornyl methacrylate, cyclohexyl methacrylate, methyl methacrylate, and mixtures of these.

In some embodiments, Part A comprises two or more methacrylate monomers.

In a preferred embodiment, Part A comprises tetrahydrofurfuryl methacrylate (CAS [2455-24-5]).

In another preferred embodiment, Part A comprises cyclohexyl methacrylate (CAS [101-43-9].

In another preferred embodiment, Part A comprises methacrylic acid.

In a particularly preferred embodiment, Part A comprises tetrahydrofurfuryl methacrylate and cyclohexyl methacrylate.

In another particularly preferred embodiment, Part A comprises tetrahydrofurfuryl methacrylate, cyclohexyl methacrylate and methacrylic acid.

In another preferred embodiment, Part A comprises an adhesion promoter, in the form of a divalent metal salt of methacrylic acid, in particular zinc dimethacrylate.

In another preferred embodiment, Part A comprises a cross-linker. The cross-linker is a molecule having a molecular weight of 1,000 Da or less, and two or more methacrylate groups. In a preferred embodiment, the cross-linker has a molecular weight of 900 Da or less.

In another preferred embodiment, the cross-linker has two methacrylate groups.

In another preferred embodiment, the cross-linker has a molecular weight of 900 Da or less and two methacrylate groups.

Examples of suitable cross-linker are molecules of the following general Formula II:

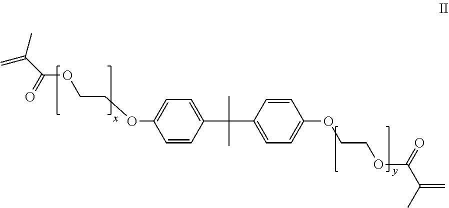

where x and y are independently selected from 2-10. In a preferred embodiment, x and y are both 5.

If used, the cross-linker is preferably present at 0.5-2.5 wt %, more preferably 0.6-1.25 wt %, particularly preferably 0.6-0.8 wt %, based on the total weight of Part A.

In a preferred embodiment, the cross-linker is of the general formula II and is present at 0.5-2.5 wt %, more preferably 0.6-1.25 wt %, particularly preferably 0.6-0.8 wt %, based on the total weight of Part A.

In another particularly preferred embodiment, Part A comprises tetrahydrofurfuryl methacrylate, cyclohexyl methacrylate, and a divalent metal salt of methacrylic acid, in particular zinc dimethacrylate.

The methacrylate monomer or monomers, other than the adhesion promoter and the cross-linker, preferably represent 10-30 wt %, more preferably 12-25 wt % of Part A, particularly preferably 14-20 wt %, based on the total weight of Part A.

In a preferred embodiment, Part A comprises 0.3-8 wt %, more preferably 0.5-5 wt % tetrahydrofurfuryl methacrylate, based on the total weight of Part A.

In another preferred embodiment, Part A comprises 5-20 wt %, more preferably 7-15 wt %, more particularly preferably 10-13 wt %, cyclohexyl methacrylate, based on the total weight of Part A.

In another preferred embodiment, Part A comprises 1-6 wt %, more preferably 2-4 wt % methacrylic acid, based on the total weight of Part A.

In another preferred embodiment, Part A comprises 0.25-4 wt %, more preferably 0.5-1.5 wt % of a divalent metal salt of methacrylic acid, based on the total weight of Part A.

In another preferred embodiment, Part A comprises 0.5-4 wt %, more preferably 0.75-1.5 wt % of zinc dimethacrylate, based on the total weight of Part A.

In another preferred embodiment, Part A comprises 0.3-8 wt %, more preferably 0.5-5 wt % tetrahydrofurfuryl methacrylate, based on the total weight of Part A, and 5-20 wt %, more preferably 7-15 wt %, more particularly preferably 10-13 wt %, cyclohexyl methacrylate, based on the total weight of Part A.

In another preferred embodiment, Part A comprises 0.3-8 wt %, more preferably 0.5-5 wt % tetrahydrofurfuryl methacrylate, based on the total weight of Part A, 5-20 wt %, more preferably 7-15 wt %, more particularly preferably 10-13 wt %, cyclohexyl methacrylate, based on the total weight of Part A, and 1-6 wt %, more preferably 2-4 wt % methacrylic acid, based on the total weight of Part A.

In another preferred embodiment, Part A comprises 0.3-8 wt %, more preferably 0.5-5 wt % tetrahydrofurfuryl methacrylate, based on the total weight of Part A, 5-20 wt %, more preferably 7-15 wt %, more particularly preferably 10-13 wt %, cyclohexyl methacrylate, based on the total weight of Part A, 1-6 wt %, more preferably 2-4 wt % methacrylic acid, based on the total weight of Part A, and 0.5-4 wt %, more preferably 0.75-1.5 wt % of zinc dimethacrylate, based on the total weight of Part A.

At Least One Toughener (aii)

Part A comprises at least one elastomeric toughener.

The toughener may be any elastomer that is compatible with the adhesive matrix. Such tougheners are preferably selected from chlorinated or chlorosulphonated polyethylenes, block copolymers of styrene and conjugated dienes (SBS, SIS), ethylene acrylic elastomers, core-shell graft copolymers, polyurethane-based tougheners, polybutadienes, and butadiene-acrylonitrile-based tougheners.

In a preferred embodiment, the at least one toughener is selected from acrylate or methacrylate functional polyurethanes, vinyl terminated polybutadienes, and vinyl terminated butadiene-acrylonitrile.

### Polyurethane-Based Tougheners

Polyurethane-based tougheners are prepared by reacting a polyether polyol with a polyisocyanate in a ratio such that the resulting polymer is an NCO-capped polymer, followed by end-capping with a hydroxyalkyl ester of methacrylic acid or acrylic acid.

The polyether polyol is not particularly limited. It may be a diol or triol, with diols being preferred.

In a preferred embodiment, the polyol is a poly(C₂-C₆-alkylene oxide) diol, with C₂, C₃ and C₄ being preferred, and C₄ being particularly preferred [i.e. poly(tetramethylene oxide)glycol or PTMEG].

In another preferred embodiment, the polyether polyol is selected from PTMEG's having molecular weights from 1,000 to 3,000 Da, more preferably 2,000 Da.

The toughener may also comprise a low molecular weight (<250 Da) polyol having functionality of 3 or 4, such as trimethylol propane. If present, the low molecular weight polyol is preferably used at 0.1-3 wt %, more preferably 0.25-1 wt %, particularly preferably 0.5 wt %, based on the total weight of the toughener. In a preferred embodiment, the toughener comprises trimethylol propane at 0.1-3 wt %, more preferably 0.25-1 wt %, particularly preferably 0.5 wt %, based on the total weight of the toughener.

The polyisocyanate is not particularly limited. It may be aliphatic or aromatic, with aliphatic being preferred.

The polyisocyanate is preferably a diisocyanate.

In a preferred embodiment, the polyisocyanate is an aliphatic diisocyanate. Examples include hexamethylene diisocyanate (HDI), isophorone diisocyanate, methylene dicyclohexyl diisocyanate.

In a preferred embodiment, the polyether polyol is a diol, and the polyisocyanate is a diisocyanate.

In another preferred embodiment, the polyether polyol is an aliphatic diol, and the polyisocyanate is an aliphatic diisocyanate.

In another preferred embodiment, the polyether polyol is PTMEG and the polyisocyanate is HDI.

The hydroxyalkyl ester of methacrylic acid is preferably a C₂-C₆-hydroxyalkyl ester, more preferably C₂-C₄-hydroxyalkyl, even more preferably C₂-C₃-hydroxyalkyl, with C₂-hydroxyalkyl being the most preferred, in particular hydroxyethyl methacrylate (HEMA):

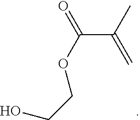

The toughener is preferably made by reacting the polyether polyol with the polyisocyanate, in the presence of a polyurethane catalyst to produce an NCO-terminated prepolymer. The prepolymer is then reacted with a hydroxyalkyl ester of methacrylic acid, resulting in end-capping.

In a preferred embodiment, the toughener is made by reacting PTMEG with HDI, in the presence of a polyurethane catalyst to produce an NCO-terminated prepolymer. The prepolymer is then reacted with HEMA, resulting in end-capping. The resulting toughener is of the general Formula III:

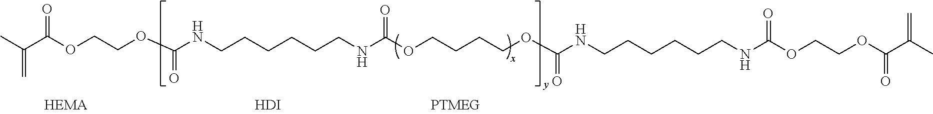

where x has a value between 13 and 42, more preferably 27.8 (this corresponds to a PTMEG of molecular weight 1,000 to 3,000 Da, more preferably 2,000 Da), and y has values of 1.5 to 5 or 1.8 to 4.9, more preferably 2.6.

In a preferred embodiment, the toughener is of the general Formula III, having a number average molecular weight (Mn) of 6,119 Da, as determined by gel permeation chromatography (GPC), according to the method recited in the Examples section.

In a preferred embodiment, the toughener is of general Formula III, the PTMEG has a molecular weight of 2,000 Da, and the toughener has a number average molecular weight (Mn) of 6,119 Da, as determined by gel permeation chromatography (GPC), according to the method recited in the Examples section.

In a preferred embodiment, the toughener is of the general Formula III, having a weight average molecular weight (Mw) of 15,084 Da, as determined by gel permeation chromatography (GPC), according to the method recited in the Examples section.

In a preferred embodiment, the toughener is of general Formula III, the PTMEG has a molecular weight of 2,000 Da, and the toughener has a weight average molecular weight (Mw) of 15,084 Da, as determined by gel permeation chromatography (GPC), according to the method recited in the Examples section.

### Rubber-Based Tougheners

Suitable rubber-based tougheners are those that have a rubber core terminated with methacrylate or acrylate groups.

The rubber may be selected from, for example, silicone, polybutadiene, acrylonitrile-butadiene, polyacrylate or polymethacrylate, and mixtures of these.

### Content of Elastomeric Toughener

In a preferred embodiment, Part A comprises 5-20 wt %, more preferably 7-15 wt %, particularly preferably 8-12 wt % of toughener (aii), based on the total weight of Part A.

In another preferred embodiment, Part A comprises 5-20 wt %, more preferably 7-15 wt %, particularly preferably 8-12 wt % of toughener (aii), based on the total weight of Part A, wherein the toughener is a rubber-based toughener terminated with methacrylate groups.

In another preferred embodiment, Part A comprises 5-20 wt %, more preferably 7-15 wt %, particularly preferably 8-12 wt % of toughener (aii), based on the total weight of Part A, wherein the toughener is a rubber-based toughener terminated with methacrylate groups, wherein the rubber is selected from polyurethane, silicone, polybutadiene, acrylonitrile butadiene, polyacrylate or polymethacrylate, and mixtures of these.

In another preferred embodiment, Part A comprises 5-20 wt %, more preferably 7-15 wt %, particularly preferably 8-12 wt % of toughener (aii), based on the total weight of Part A, wherein the toughener is wherein the toughener is made by reacting an aliphatic polyether diol with an aliphatic diisocyanate.

In another preferred embodiment, Part A comprises 5-20 wt %, more preferably 7-15 wt %, particularly preferably 8-12 wt % of toughener (aii), based on the total weight of Part A, wherein the toughener is made by reacting an aliphatic polyether diol with an aliphatic diisocyanate, followed by end-capping with a C₂-C₆-hydroxyalkyl ester, more preferably C₂-C₄-hydroxyalkyl, even more preferably C₂-C₃-hydroxyalkyl ester of methacrylic acid, with C₂-hydroxyalkyl being the most preferred (hydroxyethyl methacrylate, HEMA).

In another preferred embodiment, Part A comprises 5-20 wt %, more preferably 7-15 wt %, particularly preferably 8-12 wt % of toughener (aii), based on the total weight of Part A, wherein the toughener is made by reacting PTMEG with HDI, followed by end-capping with a C₂-C₆-hydroxyalkyl ester, more preferably C₂-C₄-hydroxyalkyl, even more preferably C₂-C₃-hydroxyalkyl ester of methacrylic acid, with C₂-hydroxyalkyl being the most preferred (hydroxyethyl methacrylate, HEMA).

In another preferred embodiment, Part A comprises 5-20 wt %, more preferably 7-15 wt %, particularly preferably 8-12 wt % of toughener (aii), based on the total weight of Part A, wherein the toughener is made by reacting PTMEG with HDI, followed by end-capping with HEMA.

In another preferred embodiment, Part A comprises 5-20 wt %, more preferably 7-15 wt %, particularly preferably 8-12 wt % of toughener (aii), based on the total weight of Part A, wherein the toughener is of Formula III:

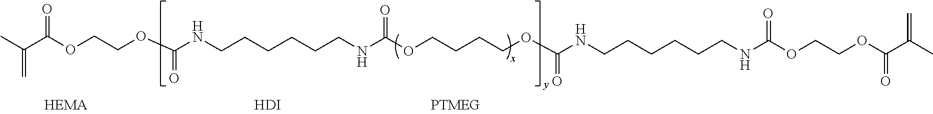

where x has a value between 13 and 42, more preferably 27.73 (this corresponds to a PTMEG of molecular weight 1,000 to 3,000 Da, more preferably 2,000 Da), and y has values of 1.5 to 5 or 1.8 to 4.9, more preferably 2.6.
   Phosphorus-Containing Compound (aiii)

Part A comprises a phosphorus-containing compound selected from mono-esters of phosphonic, mono- and di-esters of phosphonic and mono-, di- and tri-esters of phosphoric acid having one unit of vinyl or allylic unsaturation present.

Preferably the phosphorus-containing compound (aiii) is of the Formulae IV, V and VI:

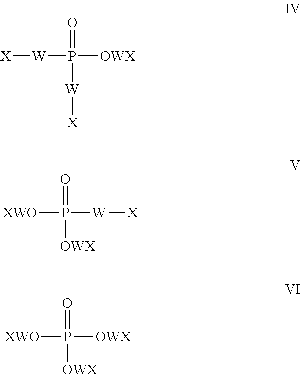

where W is the same or different, and each W is independently selected from H, and a divalent organic radical, with at least one W being a divalent organic radical, and at least one X is a vinyl group, and the other(s) is (are) a vinyl group or absent (in case W is H), or H.

In another preferred embodiment, the phosphorus-containing compound (aiii) is of Formula VI.

In another preferred embodiment, the phosphorus-containing compound (aiii) is of Formula VI and one, two or three X groups are vinyl. Preferably one X group is vinyl.

In another preferred embodiment, the phosphorus-containing compound (aiii) is of Formula VI and one, two or three WX groups are of the Formula VII:

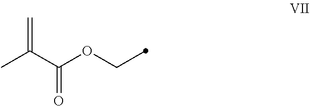

where the dot represents the point of radical attachment. In the case where one or two WX groups are of Formula VII, the remaining WX group(s) is (are) preferably H. In a particularly preferred embodiment, one WX group is of Formula VI, and the remaining WX groups are H, yielding the Formula VIII:

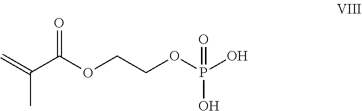

In another particularly preferred embodiment, two WX groups are of the Formula VII, and the remaining WX group is H, yielding the Formula IX:

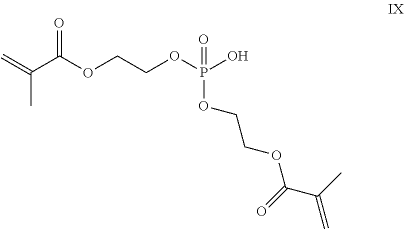 [SMILES: C=C(C)C(=O)OCCOP(=O)(O)OCCOC(=O)C(=C)C]

In another preferred embodiment, the phosphorus-containing compound (aiii) is an approximate 2:1 mixture of Formula VIII and Formula IX.

Other examples of the phosphorus-containing compound include, without limitation, phosphoric acid; 2-methacryloyloxyethyl phosphate; bis-(2-methacryloxyloxyethyl)phosphate; 2-acryloyloxyethyl phosphate; bis-(2-acryloyloxyethyl)phosphate; methyl-(2-methacryloyloxyethyl)phosphate; ethyl methacryloyloxyethyl phosphate; methyl acryloyloxyethyl phosphate; ethyl acryloyloxyethyl phosphate; propyl acryloyloxyethyl phosphate, isobutyl acryloyloxyethyl phosphate, ethylhexyl acryloyloxyethyl phosphate, halopropyl acryloyloxyethyl phosphate, haloisobutyl acryloyloxyethyl phosphate or haloethylhexyl acryloyloxyethyl phosphate; vinyl phosphonic acid; cyclohexene-3-phosphonic acid; (α-hydroxybutene-2 phosphonic acid; 1-hydroxy-1-phenylmethane-1,1-diphosphonic acid; 1-hydroxy-1-methyl-1-disphosphonic acid: 1-amino-1phenyl-1,1-diphosphonic acid; 3-amino-3-hydroxypropane-1,1-disphosphonic acid; amino-tris(methylenephosphonic acid); gamma-amino-propylphosphonic acid; gamma-glycidoxypropylphosphonic acid; phosphoric acid-mono-2-aminoethyl ester; allyl phosphonic acid; allyl phosphinic acid; β-methacryloyloxyethyl phosphinic acid; diallylphosphinic acid; β-methacryloyloxyethyl)phosphinic acid and allyl methacryloyloxyethyl phosphinic acid. Preferred phosphorus compounds are 2-hydroxyethylmethacrylate phosphate and phosphonated (meth)acrylic monomer.

Tertiary Amine Radical Initiator (aiv)

Part A comprises a tertiary amine radical initiator. The tertiary amine radical initiator is not particularly limited.

Preferred tertiary amine radical initiators are of the general Formula X:

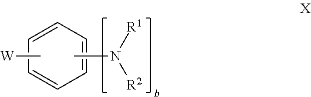

wherein W is selected from the group consisting of hydrogen, hydroxy, amino, halogen, alkyl having 1 to 8, preferably 1 to 4, carbon atoms, and alkoxy having 1 to 8, preferably 1 to 4, carbon atoms; R¹ and R² are independently selected from branched or linear C₁₋₄-alkyl; and b is 1 or 2.

Examples include N, N-dimethyl aniline, N, N-dimethylaminomethylphenol and N,N-dimethyl-p-toluidine.

In a particularly preferred embodiment, the tertiary amine radical initiator is N,N-dimethyl-p-toluidine.

The tertiary amine radical initiator is preferably used at 0.1-0.6 wt %, more preferably, 0.2-0.4 wt %, based on the total weight of Part A.

In a preferred embodiment, the tertiary amine radical initiator is N,N-dimethyl-p-toluidine, used at 0.1-0.6 wt %, more preferably, 0.2-0.4 wt %, based on the total weight of Part A.

### Diethylhydroxylamine (av)

Part A comprises from 0.0025-0.065 wt % diethylhydroxylamine.

In a preferred embodiment, diethylhydroxylamine is present in Part A at 0.015-0.06 wt %, more preferably at 0.2-0.055 wt %, based on the total weight of Part A.

### At Least One Epoxy Resin (bi)

Part B comprises at least one epoxy resin.

Suitable epoxy resins include the diglycidyl ethers of polyhydric phenol compounds such as resorcinol, catechol, hydroquinone, bisphenol, bisphenol A, bisphenol AP (1,1-bis(4-hydroxylphenyl)-1-phenyl ethane), bisphenol F, bisphenol K, bisphenol M, tetramethylbiphenol, diglycidyl ethers of aliphatic glycols and polyether glycols such as the diglycidyl ethers of C₂₋₂₄ alkylene glycols and poly(ethylene oxide) or poly(propylene oxide)glycols; polyglycidyl ethers of phenol-formaldehyde novolac resins, alkyl substituted phenol formaldehyde resins (epoxy novalac resins), phenolhydroxybenzaldehyde resins, cresol-hydroxybenzaldehyde resins, dicyclopentadiene-phenol resins and dicyclopentadiene-substituted phenol resins, and any combination thereof. Suitable diglycidyl ethers include diglycidyl ethers of bisphenol A resins such as are sold by Olin Corporation under the designations D.E.R.®330, D.E.R.®331, D.E.R.®332, D.E.R.®383, D.E.R.®661 and D.E.R.®662 resins.

In a preferred embodiment, the at least one epoxy resin comprises a reaction product of epichlorohydrin and bisphenol A.

In another preferred embodiment, the at least one epoxy resin comprises a liquid reaction product of epichlorohydrin and bisphenol A.

In a preferred embodiment, the at least one epoxy resin comprises an epoxy resin that is a liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5,200-5,500 mmol/kg (as measured according to ASTM D-1652), and a viscosity at 25° C. of 11,000-14,000 mPas (as measured according to ASTM D-445).

In another preferred embodiment, the at least one epoxy resin comprises a bisphenol A/F-based epoxy resin having an epoxide equivalent weight of 345-365 g/eq.

In a particularly preferred embodiment, the at least one epoxy resin comprises a mixture of a liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5,200-5,500 mmol/kg (as measured according to ASTM D-1652), and a viscosity at 25° C. of 11,000-14,000 mPas (as measured according to ASTM D-445), and a bisphenol A/F-based epoxy resin having an epoxide equivalent weight of 345-365 g/eq.

In a preferred embodiment, the at least one epoxy resin comprises 50-95 wt %, more preferably 60-80 wt % of a liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5,200-5,500 mmol/kg (as measured according to ASTM D-1652), and a viscosity at 25° C. of 11,000-14,000 mPas (as measured according to ASTM D-445), based on the total weight of epoxy resin in Part B.

In another preferred embodiment, the at least one epoxy resin comprises 5-50 wt %, more preferably 20-40 wt % of a bisphenol A/F-based epoxy resin having an epoxide equivalent weight of 345-365 g/eq, based on the total weight of epoxy resin in Part B.

In another preferred embodiment, the at least one epoxy resin comprises 50-95 wt %, more preferably 60-80 wt % of a liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5,200-5,500 mmol/kg (as measured according to ASTM D-1652), and a viscosity at 25° C. of 11,000-14,000 mPas (as measured according to ASTM D-445), and 5-50 wt %, more preferably 20-40 wt % of a bisphenol A/F-based epoxy resin having an epoxide equivalent weight of 345-365 g/eq, based on the total weight of epoxy resin in Part B.

Part B preferably comprises the at least one epoxy resin at from 10 to 30 wt %, more preferably 12 to 20 wt %, more particularly preferably 14 to 16 wt % of epoxy resin, based on the total weight of Part B.

Oxidizing Agent (bii)

Part B comprises an oxidizing agent. The oxidizing agent is not particularly limited.

Representative oxidizing agents including, without limitation, organic peroxides, such as benzoyl peroxide and other diacyl peroxides, hydroperoxides such as cumene hydroperoxide, peresters such as β-butylperoxybenzoate; ketone hydroperoxides such as methyl ethyl ketone hydroperoxide, organic salts of transition metals such as cobalt naphthenate, and compounds containing a labile chlorine such as sulfonyl chloride. The most preferred oxidizing agent is benzoyl peroxide.

The oxidizing agent, preferably organic peroxide, is preferably present in Part B at 1.5-5 wt %, more preferably 2-4 wt %, based on the total weight of Part B.

In a preferred embodiment, Part B comprises benzoyl peroxide at 1.5-5 wt %, more preferably 2-4 wt %, based on the total weight of Part B.

### Thermally-Conductive Filler

The adhesives of the invention comprise thermally-conductive filler such that when Part A and Part B are mixed together to form an adhesive mixture, the adhesive mixture comprises from 40-90 wt % thermally-conductive filler.

In a preferred embodiment, the adhesives of the invention comprise thermally-conductive filler such that when Part A and Part B are mixed together to form an adhesive mixture, the adhesive mixture comprises from 40-70 wt % thermally-conductive filler.

The thermally-conductive filler preferably comprises, consists essentially of, or consists entirely of one or more thermally-conductive fillers having thermal conductivities of about 3 W/mK to about 80 W/mK.

Examples of suitable thermally-conductive fillers include aluminum hydroxide, aluminium oxide, aluminium powder, zinc oxide, boron nitride, and mixtures of these. Particularly preferable the filler is selected from aluminium hydroxide, aluminium oxide and mixtures of these. Most particularly preferred is aluminium hydroxide.

The thermally-conductive filler preferably has a sufficiently low Mohs hardness so that it is generally non-abrasive. Preferably, the conductive filler has a Mohs hardness of about 7.0 or less, preferably about 5.0 or less, and more preferably about 4.0 or less. The conductive filler may have a Mohs hardness of about 0.5 or more, about 1.5 or more, or about 2.0 or more. An example of a non-abrasive conductive filler is aluminium hydroxide (i.e. ATH) powder, which typically has a Mohs hardness of 2.5-3. Aluminium hydroxide powder has a thermal conductivity between 3 and 80 W/mK, typically about 10 W/mK.

The adhesive mixture formed by mixing Part A and Part B includes sufficient thermally-conductive filler so that the thermal conductivity of the adhesive mixture, once cured, is at least about 0.9 W/mK or more, preferably about 1.0 W/mK or more.

Thermal conductivity is measured according to ASTM 5470-12 on a thermal interface material tester from ZFW Stuttgart, with tests performed in Spaltplus mode at a thickness of between 1.8-1.2 mm; the described thermal interface material is considered as Type I (viscous liquids) as described in ASTM 5470-12, the upper contact is heated to ca 40° C. and the lower contact to ca 10° C., resulting in a sample temperature of ca 25° C.

In a preferred embodiment, the thermally-conductive filler is ATH.

Particularly preferably, the thermally-conductive filler is ATH having a multimodal particle size distribution. The expression multimodal particle size distribution means that if the particle sizes are plotted with particle size on the x-axis and vol % on the y-axis, at least two main peaks are observed. When substantially only two main peaks are observed, the expression bimodal is used.

Particularly preferably, the thermally-conductive filler is ATH having a bimodal particle size distribution.

The particle size distribution of the aluminium trihydroxide is typically measured using laser diffraction, using water containing sodium pyrophosphate as a suspending agent.

In a preferred embodiment, the aluminium trihydroxide has the following particle size distribution:

$${D}_{10} = 0.5 μ m$$

$${D}_{50} = 8 μ m$$

$${D}_{90} = 80 μ m .$$

The thermally-conductive filler is present in Part A and/or Part B such that when the two components are mixed (preferably in a 2:1 to 10:1, more preferably 4:1 volumetric ratio) to form an adhesive mixture, the concentration of thermally-conductive filler in the adhesive mixture is least 40 wt % based on the total weight of the adhesive mixture. In a preferred embodiment, the concentration of thermally-conductive filler in the adhesive mixture is from 55-65 wt %, based on the total weight of the adhesive mixture.

The thermally-conductive filler may be present in Part A, Part B or both. Preferably, both Part A and Part B comprise thermally-conductive filler.

In a preferred embodiment, the concentration of thermally-conductive filler in Part A is from 40-90 wt %, more preferably 55-62 wt %, particularly preferably 44-57 wt %, based on the total weight of Part A.

In a preferred embodiment, the concentration of thermally-conductive filler in Part B is from 55-90 wt %, more preferably 60-70 wt %, particularly preferably 44-57 wt %, based on the total weight of Part B.

In a preferred embodiment, the concentration of thermally-conductive filler in Part A is from 40-65 wt %, more preferably 55-62 wt %, particularly preferably 44-57 wt %, based on the total weight of Part A, and the concentration of thermally-conductive filler in Part B is from 55-90 wt %, more preferably 60-70 wt %, particularly preferably 44-57 wt %, based on the total weight of Part B.

### Optional Ingredients

The adhesives of the invention may contain additional optional ingredients, such as, for example:

Stabilizers/free-radical scavengers may be added to both Part A and Part B, to extend shelf-life of the unmixed parts. Examples of stabilizers/free-radical scavengers include 1, 3, 5-TRIMETHYL-2,4,6-TRIS (3,5-DI-TERT-BUTYL-4-HYDROXYBENZYL) BENZENE, butylated hydroxy toluene (BHT), methyl ether of hydroquinone, hydroquinone, benzoquinone, naphthoquinone, and nitrile oxides.

Fillers such as wollastonite, talc, fumed silica, calcium carbonate and glass.

Additional optional ingredients may include, for example, adhesion promoters, pigments, thixotropic agents, wetting agents, reactive diluents, antioxidants, inhibitors, and stabilizers.

Suitable adhesion promoters include mono- and polysiloxanes functionalized with functionalities that can react with the epoxy or methacrylate components, as well as trialkoxysilanes with epoxy, amine or mercapto functionality.

### Method of Manufacture

The liquid ingredients of Part A are typically mixed to homogeneity under vacuum or inert atmosphere. The solid ingredients are then added and the mixture is mixed to homogeneity. The tertiary amine radical initiator is then added. Part A can be stored under vacuum or inert atmosphere until use.

Part B is typically manufactured by mixing the liquid ingredients (except for the oxidizing agent) to homogeneity under vacuum or inert atmosphere. The solid ingredients are then mixed in and once the mixture is homogenous, the oxidizing agent is added. Part B can be stored under vacuum or inert atmosphere until use.

### Method of Use

In use, the adhesive Part A and Part B are mixed to homogeneity and applied to a substrate immediately. Typical mixing ratios of A:B are 2:1 to 10:1 with 4:1 being particularly preferred.

Suitable substrates include, for example, electrogalvanized steel, hot dipped galvanized steel, cold rolled steel, aluminium, nickel plated steel, polymers and polymeric composites.

### Effect of the Invention

The adhesives of the invention preferably show lap shear strengths on cold-rolled steel, of 10 MPa or greater, using the following test method: specimens are prepared and tested in accordance with SAE J1523 [2012 02 01]. 25.4 mm×101.6 mm specimens are mated with a 12.7 mm overlap and 0.10 mm bondline thickness and then allowed to cure at room temperature. The specimens are tested at a rate of 12.7 mm/min.

The adhesives of the invention preferably show lap shear strengths on nickel-plated steel, of 10 MPa or greater, using the following test method: specimens are prepared and tested in accordance with SAE J1523 [2012 02 01]. 25.4 mm×101.6 mm specimens are mated with a 12.7 mm overlap and 0.10 mm bondline thickness and then allowed to cure at room temperature. The specimens are tested at a rate of 12.7 mm/min.

The adhesives of the invention preferably show a failure mode of at least 90%, more preferably at least 95%, cohesive failure on cold-rolled steel, when tested as described above for lap shear strength.

The adhesives of the invention preferably show a failure mode of at least 50%, more preferably at least 80%, cohesive failure on nickel-plated steel, when tested as described above for lap shear strength.

The adhesives of the invention show good storage stability, as evidenced by absence of gelling of Part A after two weeks of heat-ageing at 54° C.

### Particularly Preferred Embodiments

The following are particularly preferred embodiments of the invention:
1. A two-component, thermally-conductive epoxy-acrylic hybrid adhesive, comprising:
   Part A
      ai) at least one methacrylate monomer;
      aii) at least one elastomeric toughener;
      aiii) a phosphorus-containing compound with mono-esters of phosphonic, mono- and di-esters of phosphonic and phosphoric acids having one unit of vinyl or allylic unsaturation present;
      aiv) a tertiary amine radical initiator;
      av) from 0.0025-0.065 wt % diethylhydroxylamine;
   Part B
      bi) at least one epoxy resin;
      bii) an oxidizing agent;
   wherein Part A and/or Part B comprise thermally-conductive filler such that when Part A and Part B are mixed together to form an adhesive mixture, the adhesive mixture comprises from 40-90 wt % thermally-conductive filler.
2. A method for adhering two or more substrates, comprising the steps: (1) providing a two-component, thermally-conductive epoxy-acrylic hybrid adhesive, comprising:
   Part A
      ai) at least one methacrylate monomer;
      aii) at least one elastomeric toughener;
      aiii) a phosphorus-containing compound with mono-esters of phosphonic, mono- and di-esters of phosphonic and phosphoric acids having one unit of vinyl or allylic unsaturation present;
      aiv) a tertiary amine radical initiator;
      av) from 0.0025-0.065 wt % diethylhydroxylamine;
   Part B
      bi) at least one epoxy resin;
      bii) an oxidizing agent;
   wherein Part A and/or Part B comprise thermally-conductive filler such that when Part A and Part B are mixed together to form an adhesive mixture, the adhesive mixture comprises from 40-90 wt % thermally-conductive filler;
   (2) mixing Part A and Part B to obtain an adhesive mixture;
   (3) applying the adhesive mixture to a first substrate, a second substrate or both;
   (4) bringing the first substrate and the second substrate into adhesive contact; and
   (5) allowing the adhesive mixture to cure.
3. Embodiment 1 or 2, wherein the at least one methacrylate monomer is of the general Formula I:

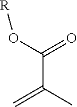

where R is an organic radical.
4. Embodiment 3, wherein R is selected from H, a C₁-C₁₈ substituted or unsubstituted cyclic or noncyclic aliphatic hydrocarbon radical, which may contain one or more heteroatoms, and a C₄-C₁₈ aromatic hydrocarbon radical, which may contain one or more heteroatoms.
5. Embodiment 3, wherein R is selected from a C₁-C₁₈ substituted or unsubstituted, cyclic or noncyclic aliphatic hydrocarbon radical, which may contain one or more heteroatoms, in particular R is cyclohexyl or CH₂-THF, where THE is a 2- or 3-tetrahydrofurfuryl radical.
6. Any one preceding embodiment, wherein the at least one methacrylate monomer is selected from isobornyl methacrylate, cyclohexyl methacrylate, methyl methacrylate, and mixtures of these.
7. Any one preceding embodiment, wherein Part A comprises two or more methacrylate monomers.
8. Any one preceding embodiment, wherein Part A comprises tetrahydrofurfuryl methacrylate (CAS [2455-24-5]).
9. Any one preceding embodiment, wherein Part A comprises cyclohexyl methacrylate (CAS [101-43-9].
10. Any one preceding embodiment, wherein Part A comprises methacrylic acid.
11. Any one preceding embodiment, wherein Part A comprises tetrahydrofurfuryl methacrylate and cyclohexyl methacrylate.
12. Any one preceding embodiment, wherein Part A comprises tetrahydrofurfuryl methacrylate, cyclohexyl methacrylate and methacrylic acid.
13. Any one preceding embodiment, wherein Part A comprises an adhesion promoter, in the form of a divalent metal salt of methacrylic acid, in particular zinc dimethacrylate.
14. Any one preceding embodiment, wherein Part A comprises a cross-linker.
15. Embodiment 14, wherein the cross-linker is a molecule having a molecular weight of 1,000 Da or less, and two or more methacrylate groups.
16. Embodiment 14 or 15, wherein the cross-linker has a molecular weight of 900 Da or less.
17. Embodiment 14, 15 or 16, wherein the cross-linker has two methacrylate groups.
18. Embodiment 14, wherein the cross-linker has a molecular weight of 900 Da or less and two methacrylate groups.
19. Any one preceding embodiment, wherein Part A comprises a cross-linker having the following general Formula II:

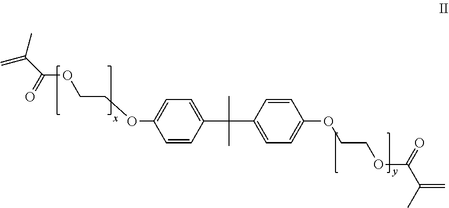

where x and y are independently selected from 2-10, preferably x and y are both 10.
20. Any one preceding embodiment, wherein Part A comprises a cross-linker at 0.5-2.5 wt %, more preferably 0.6-1.25 wt %, particularly preferably 0.6-0.8 wt %, based on the total weight of Part A.
21. Any one preceding embodiment, wherein Part A comprises a cross-linker of the general formula II and is present at 0.5-2.5 wt %, more preferably 0.6-1.25 wt %, particularly preferably 0.6-0.8 wt %, based on the total weight of Part A.
22. Any one preceding embodiment, wherein Part A comprises tetrahydrofurfuryl methacrylate, cyclohexyl methacrylate, and a divalent metal salt of methacrylic acid, in particular zinc dimethacrylate.
23. Any one preceding embodiment, wherein the methacrylate monomer or monomers, other than the adhesion promoter and the cross-linker, represent 10-30 wt %, more preferably 12-25 wt % of Part A, particularly preferably 14-20 wt %, based on the total weight of Part A.
24. Any one preceding embodiment, wherein Part A comprises 0.3-8 wt %, more preferably 0.5-5 wt % tetrahydrofurfuryl methacrylate, based on the total weight of Part A.
25. Any one preceding embodiment, wherein Part A comprises 5-20 wt %, more preferably 7-15 wt %, more particularly preferably 10-13 wt %, cyclohexyl methacrylate, based on the total weight of Part A.
26. Any one preceding embodiment, wherein Part A comprises 1-6 wt %, more preferably 2-4 wt % methacrylic acid, based on the total weight of Part A.
27. Any one preceding embodiment, wherein Part A comprises 0.25-4 wt %, more preferably 0.5-1.5 wt % of a divalent metal salt of methacrylic acid, based on the total weight of Part A.
28. Any one preceding embodiment, wherein Part A comprises 0.5-4 wt %, more preferably 0.75-1.5 wt % of zinc dimethacrylate, based on the total weight of Part A.
29. Any one preceding embodiment, wherein Part A comprises 0.3-8 wt %, more preferably 0.5-5 wt % tetrahydrofurfuryl methacrylate, based on the total weight of Part A, and 5-20 wt %, more preferably 7-15 wt %, more particularly preferably 10-13 wt %, cyclohexyl methacrylate, based on the total weight of Part A.
30. Any one preceding embodiment, wherein Part A comprises 0.3-8 wt %, more preferably 0.5-5 wt % tetrahydrofurfuryl methacrylate, based on the total weight of Part A, 5-20 wt %, more preferably 7-15 wt %, more particularly preferably 10-13 wt %, cyclohexyl methacrylate, based on the total weight of Part A, and 1-6 wt %, more preferably 2-4 wt % methacrylic acid, based on the total weight of Part A.
31. Any one preceding embodiment, wherein Part A comprises 0.3-8 wt %, more preferably 0.5-5 wt % tetrahydrofurfuryl methacrylate, based on the total weight of Part A, 5-20 wt %, more preferably 7-15 wt %, more particularly preferably 10-13 wt %, cyclohexyl methacrylate, based on the total weight of Part A, 1-6 wt %, more preferably 2-4 wt % methacrylic acid, based on the total weight of Part A, and 0.5-4 wt %, more preferably 0.75-1.5 wt % of zinc dimethacrylate, based on the total weight of Part A.
32. Any one preceding embodiment, wherein the toughener is selected from chlorinated or chlorosulphonated polyethylenes, block copolymers of styrene and conjugated dienes (SBS, SIS), ethylene acrylic elastomers, core-shell graft copolymers, polyurethane-based tougheners, polybutadienes, and butadiene-acrylonitrile-based tougheners.
33. Any one preceding embodiment, wherein the toughener is selected from acrylate or methacrylate functional polyurethanes, vinyl terminated polybutadienes, and vinyl terminated butadiene-acrylonitrile.
34. Any one preceding embodiment, wherein the toughener is selected from polyurethane-based tougheners and rubber-based tougheners.
35. Any one preceding embodiment, wherein the toughener is a polyurethane-based toughener, prepared by reacting a polyether polyol with a polyisocyanate in a ratio such that the resulting polymer is an NCO-capped polymer, followed by end-capping with a hydroxyalkyl ester of methacrylic or acrylic acid.
36. Any one preceding embodiment, wherein the toughener is a rubber-based toughener, wherein the rubber is selected from silicone, polybutadiene, acrylonitrile butadiene, polyacrylate or polymethacrylate, and mixtures of these, terminated with vinyl, methacrylate or acrylate groups.
37. Any one preceding embodiment, wherein Part A comprises 5-20 wt %, more preferably 7-15 wt %, particularly preferably 8-12 wt % of toughener (aii), based on the total weight of Part A.
38. Any one preceding embodiment, wherein Part A comprises 5-20 wt %, more preferably 7-15 wt %, particularly preferably 8-12 wt % of toughener (aii), based on the total weight of Part A, wherein the toughener is a rubber-based toughener terminated with methacrylate groups.
39. Any one preceding embodiment, wherein Part A comprises 5-20 wt %, more preferably 7-15 wt %, particularly preferably 8-12 wt % of toughener (aii), based on the total weight of Part A, wherein the toughener is a rubber-based toughener terminated with methacrylate groups, wherein the rubber is selected from polyurethane, silicone, polybutadiene, acrylonitrile butadiene, polyacrylate or polymethacrylate, and mixtures of these.
40. Any one preceding embodiment, wherein Part A comprises 5-20 wt %, more preferably 7-15 wt %, particularly preferably 8-12 wt % of toughener (aii), based on the total weight of Part A, wherein the toughener is wherein the toughener is made by reacting an aliphatic polyether diol with an aliphatic diisocyanate, followed by end-capping with a C₂-C₆-hydroxyalkyl ester, more preferably C₂-C₄-hydroxyalkyl, even more preferably C₂-C₃-hydroxyalkyl ester of methacrylic acid, with C₂-hydroxyalkyl being the most preferred (hydroxyethyl methacrylate, HEMA).
41. Any one preceding embodiment, wherein the phosphorus-containing compound (aiii) is of the Formulae IV, V and VI:

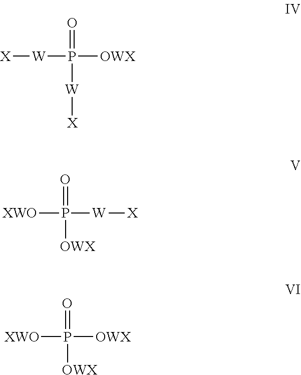

where W is the same or different, and each W is independently selected from H, and a divalent organic radical, with at least one W being a divalent organic radical, and at least one X is a vinyl group, and the other(s) is (are) a vinyl group or absent (in case W is H), or H.
42. Any one preceding embodiment, wherein the phosphorus-containing compound (aiii) is of Formula VI.
43. Any one preceding embodiment, wherein the phosphorus-containing compound (aiii) is of Formula VI and one, two or three X groups are vinyl. Preferably one X group is vinyl.
44. Any one preceding embodiment, wherein the phosphorus-containing compound (aiii) is of Formula VI and one, two or three WX groups are of the Formula VII:

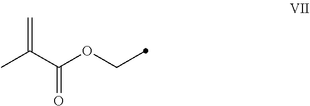

where the dot represents the point of radical attachment, in the case where one or two WX groups are of Formula VII, the remaining WX group(s) is (are) preferably H.
45. Any one preceding embodiment, wherein the phosphorus-containing compound (aiii) is of Formula VIII:

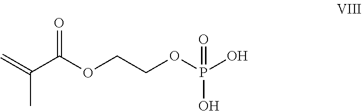

46. Any one preceding embodiment, wherein the phosphorus-containing compound (aiii) is of Formula IX:

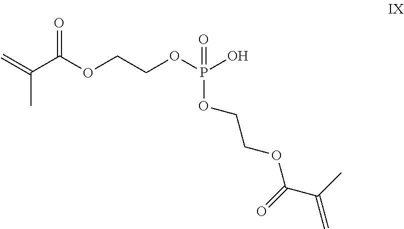 [SMILES: C=C(C)C(=O)OCCOP(=O)(O)OCCOC(=O)C(=C)C]

47. Any one preceding embodiment, wherein the phosphorus-containing compound (aiii) is an approximate 2:1 mixture of Formula VIII and Formula IX.
48. Any one preceding embodiment, wherein the phosphorus-containing compound is selected from phosphoric acid; 2-methacryloyloxyethyl phosphate; bis-(2-methacryloxyloxyethyl)phosphate; 2-acryloyloxyethyl phosphate; bis-(2-acryloyloxyethyl)phosphate; methyl-(2-methacryloyloxyethyl)phosphate; ethyl methacryloyloxyethyl phosphate; methyl acryloyloxyethyl phosphate; ethyl acryloyloxyethyl phosphate; propyl acryloyloxyethyl phosphate, isobutyl acryloyloxyethyl phosphate, ethylhexyl acryloyloxyethyl phosphate, halopropyl acryloyloxyethyl phosphate, haloisobutyl acryloyloxyethyl phosphate or haloethylhexyl acryloyloxyethyl phosphate; vinyl phosphonic acid; cyclohexene-3-phosphonic acid; (α-hydroxybutene-2 phosphonic acid; 1-hydroxy-1-phenylmethane-1,1-diphosphonic acid; 1-hydroxy-1-methyl-1-disphosphonic acid: 1-amino-1 phenyl-1,1-diphosphonic acid; 3-amino-3-hydroxypropane-1,1-disphosphonic acid; amino-tris(methylenephosphonic acid); gamma-amino-propylphosphonic acid; gamma-glycidoxypropylphosphonic acid; phosphoric acid-mono-2-aminoethyl ester; allyl phosphonic acid; allyl phosphinic acid; β-methacryloyloxyethyl phosphinic acid; diallylphosphinic acid; β-methacryloyloxyethyl)phosphinic acid and allyl methacryloyloxyethyl phosphinic acid.
49. Any one preceding embodiment, wherein the tertiary amine radical initiator (aiv) is of the general Formula X:

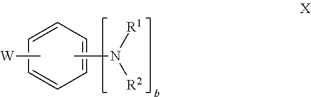

wherein W is selected from the group consisting of hydrogen, hydroxy, amino, halogen, alkyl having 1 to 8, preferably 1 to 4, carbon atoms, and alkoxy having 1 to 8, preferably 1 to 4, carbon atoms; R¹ and R² are independently selected from branched or linear C₁₋₄-alkyl; and b is 1 or 2.
50. Any one preceding embodiment, wherein the tertiary amine radical initiator is selected from N,N-dimethyl aniline, N,N-dimethylaminomethylphenol and N,N-dimethyl-p-toluidine.
51. Any one preceding embodiment, wherein the tertiary amine radical initiator is N,N-dimethyl-p-toluidine.
52. Any one preceding embodiment, wherein the tertiary amine radical initiator is used at 0.1-0.6 wt %, more preferably, 0.2-0.4 wt %, based on the total weight of Part A.
53. Any one preceding embodiment, wherein the tertiary amine radical initiator is N, N-dimethyl-p-toluidine, used at 0.1-0.6 wt %, more preferably, 0.2-0.4 wt %, based on the total weight of Part A.
54. Any one preceding embodiment, wherein diethylhydroxylamine is present in Part A at 0.015-0.06 wt %, more preferably at 0.2-0.055 wt %, based on the total weight of Part A.
55. Any one preceding embodiment, wherein the at least one epoxy resin comprises a reaction product of epichlorohydrin and bisphenol A.
56. Any one preceding embodiment, wherein the at least one epoxy resin comprises an epoxy resin that is a liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5,200-5,500 mmol/kg (as measured according to ASTM D-1652), and a viscosity at 25° C. of 11,000-14,000 mPas (as measured according to ASTM D-445).
57. Any one preceding embodiment, wherein the at least one epoxy resin comprises a bisphenol A/F-based epoxy resin having an epoxide equivalent weight of 345-365 g/eq.
58. Any one preceding embodiment, wherein the at least one epoxy resin comprises a mixture of a liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5,200-5,500 mmol/kg (as measured according to ASTM D-1652), and a viscosity at 25° C. of 11,000-14,000 mPas (as measured according to ASTM D-445), and a bisphenol A/F-based epoxy resin having an epoxide equivalent weight of 345-365 g/eq.
59. Any one preceding embodiment, wherein the at least one epoxy resin comprises 50-95 wt %, more preferably 60-80 wt % of a liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5,200-5,500 mmol/kg (as measured according to ASTM D-1652), and a viscosity at 25° C. of 11,000-14,000 mPas (as measured according to ASTM D-445), based on the total weight of epoxy resin in Part B.
60. Any one preceding embodiment, wherein the at least one epoxy resin comprises 5-50 wt %, more preferably 20-40 wt % of a bisphenol A/F-based epoxy resin having an epoxide equivalent weight of 345-365 g/eq, based on the total weight of epoxy resin in Part B.
61. Any one preceding embodiment, wherein the at least one epoxy resin comprises 50-95 wt %, more preferably 60-80 wt % of a liquid reaction product of epichlorohydrin and bisphenol A, having an epoxide equivalent weight of 182-192 g/eq (as measured according to ASTM D-1652), an epoxide percentage of 22.4-23.6% (as measured according to ASTM D-1652), an epoxide group content of 5,200-5,500 mmol/kg (as measured according to ASTM D-1652), and a viscosity at 25° C. of 11,000-14,000 mPas (as measured according to ASTM D-445), and 5-50 wt %, more preferably 20-40 wt % of a bisphenol A/F-based epoxy resin having an epoxide equivalent weight of 345-365 g/eq, based on the total weight of epoxy resin in Part B.
62. Any one preceding embodiment, wherein Part B comprises the at least one epoxy resin at from 10 to 30 wt %, more preferably 12 to 20 wt %, more particularly preferably 14 to 16 wt % of epoxy resin, based on the total weight of Part B.
63. Any one preceding embodiment, wherein the oxidizing agent (bi) is selected from organic peroxides.
64. Any one preceding embodiment, wherein the oxidizing agent (bi) is selected from diacyl peroxides, hydroperoxides, peresters, and ketone hydroperoxides.
65. Any one preceding embodiment, wherein the oxidizing agent (bi) is selected from benzoyl peroxide, cumene hydroperoxide, β-butylperoxybenzoate, and methyl ethyl ketone hydroperoxide.
66. Any one preceding embodiment, wherein the oxidizing agent (bi) is benzoyl peroxide.
67. Any one preceding embodiment, wherein the oxidizing agent (bi) is present in Part B at 1.5-5 wt %, more preferably 2-4 wt %, based on the total weight of Part B.
68. Any one preceding embodiment, wherein Part B comprises benzoyl peroxide at 1.5-5 wt %, more preferably 2-4 wt %, based on the total weight of Part B.
69. Any one preceding embodiment, wherein the thermally-conductive filler comprises, consists essentially of, or consists entirely of one or more thermally-conductive fillers having thermal conductivities of about 3 W/mK to about 80 W/mK.
70. Any one preceding embodiment, wherein the thermally-conductive filler is selected from aluminum hydroxide, aluminium oxide, aluminium powder, zinc oxide, boron nitride, and mixtures of these.
71. Any one preceding embodiment, wherein the thermally-conductive filler is aluminium hydroxide.
72. Any one preceding embodiment, wherein the adhesive mixture formed by mixing Part A and Part B includes sufficient thermally-conductive filler so that the thermal conductivity of the adhesive mixture, once cured, is at least about 0.9 W/mK or more, preferably about 1.0 W/mK or more.
73. Any one preceding embodiment, wherein the thermally-conductive filler is ATH having a multimodal particle size distribution.
74. Any one preceding embodiment, wherein the thermally-conductive filler is ATH having a bimodal particle size distribution.
75. Any one preceding embodiment, wherein the thermally-conductive filler is aluminium trihydroxide having the following particle size distribution:
   D₁₀=0.5 μm
   D₅₀=8 μm
   D₉₀=80 μm.
76. Any one preceding embodiment, wherein the thermally-conductive filler is present in Part A and/or Part B such that when the two components are mixed (preferably in a 2:1 to 10:1, more preferably 4:1 volumetric ratio) to form an adhesive mixture, the concentration of thermally-conductive filler in the adhesive mixture is least 40 wt % based on the total weight of the adhesive mixture.
77. Any one preceding embodiment, wherein the thermally-conductive filler is present in Part A and/or Part B such that when the two components are mixed (preferably in a 2:1 to 10:1, more preferably 4:1 volumetric ratio) to form an adhesive mixture, the concentration of thermally-conductive filler in the adhesive mixture is from 55-65 wt %, based on the total weight of the adhesive mixture.
78. Any one preceding embodiment, wherein the thermally-conductive filler is present in Part A, Part B or both.
79. Any one preceding embodiment, wherein both Part A and Part B comprise thermally-conductive filler.
80. Any one preceding embodiment, wherein the concentration of thermally-conductive filler in Part A is from 40-90 wt %, more preferably 55-62 wt %, particularly preferably 44-57 wt %, based on the total weight of Part A.
81. Any one preceding embodiment, wherein the concentration of thermally-conductive filler in Part B is from 55-90 wt %, more preferably 60-70 wt %, particularly preferably 44-57 wt %, based on the total weight of Part B.
82. Any one preceding embodiment, wherein the concentration of thermally-conductive filler in Part A is from 40-65 wt %, more preferably 55-62 wt %, particularly preferably 44-57 wt %, based on the total weight of Part A, and the concentration of thermally-conductive filler in Part B is from 55-90 wt %, more preferably 60-70 wt %, particularly preferably 44-57 wt %, based on the total weight of Part B.
83. Any one preceding embodiment, wherein the adhesives of the invention show lap shear strengths on cold-rolled steel, of 10 MPa or greater, using the following test method: specimens are prepared and tested in accordance with SAE J1523 [2012 02 01]. 25.4 mm×101.6 mm specimens are mated with a 12.7 mm overlap and 0.10 mm bondline thickness and then allowed to cure at room temperature, the specimens are tested at a rate of 12.7 mm/min.
84. Any one preceding embodiment, wherein the adhesives of the invention show lap shear strengths on nickel-plated steel, of 10 MPa or greater, using the following test method: specimens are prepared and tested in accordance with SAE J1523 [2012 02 01]. 25.4 mm×101.6 mm specimens are mated with a 12.7 mm overlap and 0.10 mm bondline thickness and then allowed to cure at room temperature, the specimens are tested at a rate of 12.7 mm/min.
85. Any one preceding embodiment, wherein the adhesives of the invention show a failure mode of at least 90%, more preferably at least 95%, cohesive failure on cold-rolled steel, when tested as described above for lap shear strength.
86. Any one preceding embodiment, wherein the adhesives of the invention show a failure mode of at least 50%, more preferably at least 80%, cohesive failure on nickel-plated steel, when tested as described above for lap shear strength.
87. Any one preceding embodiment, wherein the adhesives of the invention show good storage stability, as evidenced by absence of gelling of Part A after two weeks of heat-ageing at 54° C.

### EXAMPLES

Ingredients are listed in Table 1.

TABLE 1
Ingredients

| Trademark or | | |
|---|---|---|
| abbreviation | Chemical name | Structure |
| THFMA | Tetrahydrofuryl methacrylate | 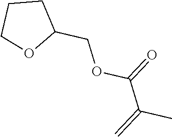 |
| Dymalink 708 | Zinc dimethacrylate | 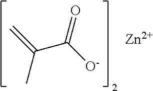 |
| CHMA | Cyclohexyl methacrylate | 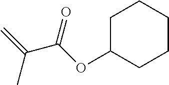 |
| SR480 | Bisphenol A ethoxylate dimethacrylate | 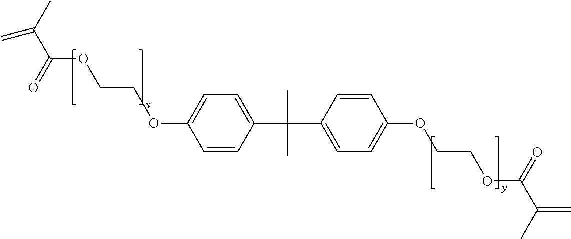 |
| | | where x and y are 5 |
| MAA | Methacrylic acid | 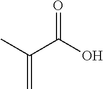 |
| Visiomer HEMA-P 70M | Hydroxyethyl- methacryl phosphate | 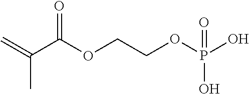 |
| | | 30% MMA as a diluent |
| Dynasylan | Vinyl oligomeric | Polysiloxane containing vinyl and ethoxy groups |
| 6498 | silane | |
| N,N- dimethyl- p-toluidine | N.N-dimethyl-p- toluidine | 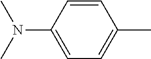 |
| Ethanox 330 | 1,3,5- TRIMETHYL- 2,4,6-TRIS (3,5-DI- TERT-BUTYL- 4-HYDROXY- BENZYL) BENZENE at 0.5 wt % in THFMA | 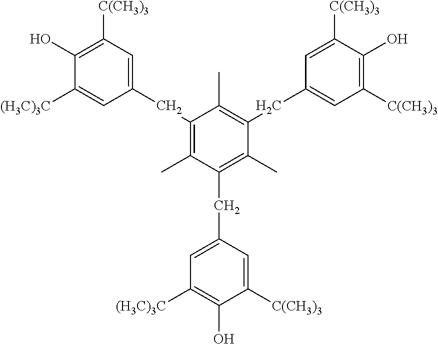 [SMILES: Cc1c(Cc2cc(C(C)(C)C)c(O)c(C(C)(C)C)c2)c(C)c(Cc2cc(C(C)(C)C)c(O)c(C(C)(C)C)c2)c(C)c1Cc1cc(C(C)(C)C)c(O)c(C(C)(C)C)c1] |
| DEHA | diethyl- hydroxylamine at 0.5 or 1 wt % in THFMA | 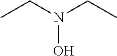 |
| APYRAL 20X | Aluminium | Bimodal aluminium trihydroxide (ATH), having the folowing particle size distribution: |
| | trihydroxide, | D₁₀ 0.5 μm |
| | bimodal | D₅₀ 8 μm |
| | | D₉₀ 80 μm |
| | | As measured by laser diffraction using acetone as the suspending medium |
| Talc 1N | Talc | |
| 5 mil glass | 5 mil glass bead | |
| beads | spacers | |
| Cab-O-Sil | Fumed silica | |
| Ultrabond 5780 | | |
| Luperox ATC- | Benzoyl peroxide | |
| 50 | paste in plasticizer | |
| Heliogen Green | Green pigment | |
| D8730 | | |
| Cardolite lite | unsaturated | |
| 2020 | long-chain | |
| | ether alcohol | |
| | based on | |
| | cashew nut | |
| | shell oil | |
| DER 331 | Liquid epoxy | Liquid epoxy resin that is a liquid reaction product of |
| | resin | epichlorohydrin and bisphenol A, having an epoxide |
| | | equivalent weight of 182-192 g/eq (as measured according |
| | | to ASTM D-1652), an epoxide percentage of 22.4- |
| | | 23.6% (as measured according to ASTM D-1652), an |
| | | epoxide group content of 5,200-5,500 mmol/kg (as |
| | | measured according to ASTM D-1652), and a |
| | | viscosity at 25º C. of 11,000-14,000 mPas (as measured |
| | | according to ASTM D-445). |
| DER 3913 | Epoxy resin | Bisphenol A/F-based epoxy resin having an epoxide equivalent weight of 345-365 g/eq |
| BHT | Butylated hydroxy toluene | 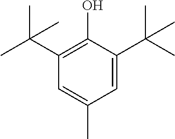 [SMILES: Cc1cc(C(C)(C)C)c(O)c(C(C)(C)C)c1] |

### Preparation of Adhesives

All formulations were mixed using a dual asymmetric centrifugal FlackTek SpeedMixer® DAC 400 FVZ by Hauschild Engineering using the following procedure.

Inventive and comparative samples were prepared using the ingredients listed in Table 2.

### Part A Procedure

The following procedures were carried out under vacuum. The acrylic monomers (THFMA, CHMA) were added to the mixer along with the zinc dimethacrylate, MAA, HEMA, Hypro (toughener), Dynasylan, SR480, Ethanox and DEHA, and the mixture was speed-mixed for two minutes at 2,300 rpm. The ATH, talc, glass beads and fumed silica were added and the mixture was speed-mixed for two minutes at 2,300 rpm. The container walls were scraped down, and the mixture speed-mixed for another two minutes at 2,300 rpm. The N, N-dimethyl-p-toluidine was added and speed-mixing was continued for an additional one minute at 2,100 rpm. The sides of the container were scraped down and mixing was continued for an additional one minute at 2,100 rpm. Part A was stored in cartridges under vacuum until use. Packaging was carried out with the material at approximately 40° C. to minimise entrapped air.

### Part B Procedure

The epoxy resins and BHT were added to the speed-mixer. The mixture was heated to 80° C. for one hour to dissolve the BHT. All other liquids, except for the Luperox (benzoyl peroxide) were added and the mixture was speed-mixed for two minutes at 2,100 rpm. The solid ingredients were added and the mixture was speed mixed for two minutes at 2,100 rpm. The sides of the container were scraped down, and mixing was continued for two minutes at 2,100 rpm. The mixture was allowed to cool to 40-50° C., the Luperox was added, and the mixture was speed-mixed for thirty seconds at 1,200 rpm, followed by two minutes at 2,100 rpm. Part B was stored in cartridges under vacuum until use. Packaging was carried out with the material at approximately 40° C. to minimise entrapped air.

### Adhesive Dispensing and Use

Part A and Part B were dispensed with a pneumatic gun through a 16-element static mixer at room temperature. Two beads of adhesive the length of the mixer were purged through the mixer before using the adhesive.

### Open Time

The two components were mixed in a 4:1 ratio by volume through a static mixer. Immediately after dispensing a bead approximately 8 cm long 8 mm wide by 5 mm high, a timer was started and the time was recorded from dispensing of adhesive until the center of bead cured to a solid/gel-determined by poking with a disposable popsicle stick. The results are listed in Table 2.

### Lap Shear Strength

Lap shear data was collected on either cold rolled steel (CRS) or plasma treated nickel-plated steel (NPS). Specimens were prepared and tested in accordance with SAE J1523 [2012 02 01]. 25.4 mm×101.6 mm specimens were mated with a 12.7 mm overlap and 0.10 mm bondline thickness and then allowed to cure at room temperature. The specimens were tested at a rate of 12.7 mm/min. The results are listed in Table 2.

### Part A Ageing Test

To test the storage stability of Part A, the mixtures were heated in an oven held at 54° C., and the time to gelling was recorded. The results are listed in Table 2.

### Thermal Conductivity

Thermal conductivity was measured according to ASTM D5470. A TIMTester from Linseis TIM was used for the test, and performed in accordance with ASTM D5470. The measurement was performed in using a Type III method in which a stackup of 1.0 mm specimens were used and silicone oil was used on the surface of each sample to reduce the contact resistance in the measurement. The bulk thermal conductivity λ (W/mK) was recorded. The results are listed in Table 2.

TABLE 2
Ingredients in compositions and performance data

| | CEE | CEF | CEG | IE5 | IE6 |
|---|---|---|---|---|---|
| Ingredient | Wt % | Wt % | Wt % | Wt % | Wt % |
| A part | | | | | |
| THFMA | 3.79 | 0.00 | 0.00 | 2.97 | 0.68 |
| Zinc dimethacrylate | 0.7 | 0.7 | 0.7 | 0.7 | 0.7 |
| CHMA | 12.09 | 10.48 | 8.19 | 12.09 | 12.09 |
| Hypro [symbol] (Methacrylate-terminated [symbol] ) | 10.00 | 10.00 | 10.00 | 10.00 | 10.00 |
| SR480 (Bisphenol A ethoxylate dimethacrylate) | 1.75 | 1.75 | 1.75 | 1.75 | 1.75 |
| Methacrylic acid | 3.00 | 3.00 | 3.00 | 3.00 | 3.00 |
| Total methacrylate monomers (other than ZDMA) | [symbol] | 13.48 | 11.19 | [symbol] | 15.77 |
| [symbol] HEMA-P 70M (Hydroxyethylmethacryl phosphate) | 2.28 | 2.28 | 2.28 | 2.28 | 2.28 |
| [symbol] (polysiloxane [symbol] with vinyl groups) | 0.35 | 0.35 | 0.35 | 0.35 | 0.35 |
| N,N-Dimethyl-p- [symbol] (DMPT) | 0.37 | 0.37 | 0.37 | 0.37 | 0.37 |
| Ethanox 330 (1,3,5-Trimethyl-2,4,6-tris(3,5-di-t-butyl-4- | 2.10 | — | — | — | — |
| hydroxybenzyl) benzene) (0.5 wt % in THFMA) | | | | | |
| DEHA ( [symbol] ) (1 wt % in THFMA) | 0.21 | 7.71 | 10.00 | 3.13 | 5.42 |
| Actual amount DEHA (wt %) | 0.0021 | 0.0771 | 0.1 | 0.0313 | 0.0542 |
| [symbol] 20X (ATH) | 60.70 | 60.70 | 60.70 | 60.70 | 60.70 |
| Talc 1N | 0.75 | 0.75 | 0.75 | 0.75 | 0.75 |
| 5 mil glass beads | 0.91 | 0.91 | 0.91 | 0.91 | 0.91 |
| Cab-O-Sil Ultrabond 5780 (fumed silica) | 1.00 | 1.00 | 1.00 | 1.00 | 1.00 |
| B part | | | | | |
| Luperox ATC50 (benzoyl peroxide, 50 wt % in tricresyl | 4.90 | 4.90 | 4.90 | 4.90 | 4.90 |
| phosphate) | | | | | |
| Cab-O-Sil Ultrabond 5780 (fumed silica) | 0.18 | 0.18 | 0.18 | 0.18 | 0.18 |
| [symbol] green (dye) | 0.07 | 0.07 | 0.07 | 0.07 | 0.07 |
| [symbol] 20X (ATH) | [symbol] | [symbol] | [symbol] | [symbol] | [symbol] |
| [symbol] lite 2020 (unsaturated long-chain ether alcohol | [symbol] | [symbol] | [symbol] | [symbol] | [symbol] |
| based on cashew nut shell oil) | | | | | |
| Talc 1N | 1.40 | 1.40 | 1.40 | 1.40 | 1.40 |
| DER 331 (bisphenol A epoxy resin) | 11.67 | 11.67 | 11.67 | 11.67 | 11.67 |
| DER 3913 (Low viscosity, High MW bisphenol A epoxy | 3.33 | 3.33 | 3.33 | 3.33 | 3.33 |
| resin) | | | | | |
| BHT (1 wt % in DER 331) | 7.00 | 7.00 | 7.00 | 7.00 | 7.00 |
| EP/POH ratio¹ | 2.48 | 2.60 | 2.48 | 2.48 | 2.48 |
| BPO/DMPT ratio | 0.94 | 0.94 | 0.94 | 0.94 | 0.94 |
| Volume mix ratio | 4:1 | 4:1 | 4:1 | 4:1 | 4:1 |
| Open time (min.) | 21 | 29 | 26 | 29 | 34 |
| Thermal conductivity (W/mK) | 1.1 | 1.1 | 1.1 | 1.1 | 1.1 |
| Lap shear strength, cold-rolled steel (MPa) (failure | [symbol] (100% | 5.4 (AF) | 1.1 (AF) | 15.3 (100% | 11.3 (100% |
| mode)² | CF) | | | CF) | CF) |
| Lap shear strength, nickel-plated steel (MPa) (failure | [symbol] (100% | 5.5 (AF) | 0.5 (AF) | 14.2 (100% | 11.0 (50% |
| mode) | CF) | | | CF) | CF) |
| Part A ageing in 54° C. oven | Gelled (24 | No gelling | No gelling | No gelling | No gelling |
| | hr) | 2 weeks | 2 weeks | 2 weeks | 2 weeks |

¹EP/POH = epoxy equivalents/P—OH equivalents
²CF = cohesive failure, AF = adhesive failure [symbol]
indicates data missing or illegible when filed

1. A two-component, thermally-conductive epoxy-acrylic hybrid adhesive, comprising:
Part A
ai) at least one methacrylate monomer;
aii) at least one elastomeric toughener terminated with methacrylate groups;
aiii) a phosphorus-containing compound with mono-esters of phosphonic, mono- and di-esters of phosphonic and phosphoric acids having one unit of vinyl or allylic unsaturation present;
aiv) a tertiary amine radical initiator;
av) from 0.0025-0.065 wt % diethylhydroxylamine, based on total weight of Part A; and
Part B
bi) at least one epoxy resin;
bii) an oxidizing agent;
wherein Part A and/or Part B comprise thermally-conductive filler such that when Part A and Part B are mixed together to form the adhesive, the adhesive comprises from 40-90 wt % thermally-conductive filler.

2. (canceled)

3. The adhesive of claim 1, wherein the at least one methacrylate monomer is of the general Formula I: 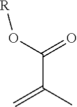
where R is an organic radical.

4. The adhesive of claim 3, wherein R is selected from H, a C₁-C₁₈ substituted or unsubstituted cyclic or noncyclic aliphatic hydrocarbon radical, and a C₄-C₁₈ aromatic hydrocarbon radical, which may contain one or more heteroatoms.

5. The adhesive of claim 3, wherein R is cyclohexyl or CH₂-THF, wherein THF is a 2- or 3-tetrahydrofurfuryl radical.

6. The adhesive of claim 1, wherein the at least one methacrylate monomer is selected from isobornyl methacrylate, cyclohexyl methacrylate, methyl methacrylate, and mixtures of these.

7. The adhesive of claim 1, wherein Part A comprises two or more methacrylate monomers.

8. The adhesive of claim 1, wherein Part A comprises tetrahydrofurfuryl methacrylate (CAS [2455-24-5]).

9. The adhesive of claim 1, wherein Part A comprises cyclohexyl methacrylate (CAS [101-43-9].

10. The adhesive of claim 1, wherein Part A comprises methacrylic acid.

11. The adhesive of claim 1, wherein Part A comprises tetrahydrofurfuryl methacrylate and cyclohexyl methacrylate.

12. The adhesive of claim 1, wherein Part A comprises tetrahydrofurfuryl methacrylate, cyclohexyl methacrylate and methacrylic acid.

13. The adhesive of claim 1, wherein Part A comprises an adhesion promoter, in the form of a divalent metal salt of methacrylic acid.

14. The adhesive of claim 1, wherein Part A comprises a cross-linker.

15. The adhesive of claim 14, wherein the cross-linker is a chemical having a molecular weight of 2,000 Da or less with two or more methacrylate groups.

16-18. (canceled)

19. The adhesive of claim 1, wherein Part A comprises a cross-linker having the following general Formula II: 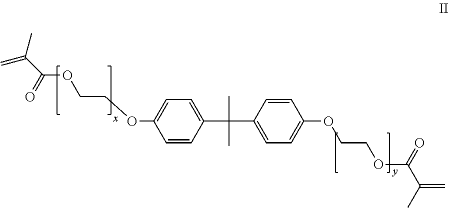
where x and y are independently selected from 2-10.

20. The adhesive of claim 14, wherein Part A comprises a cross-linker at 0.5-2.5 wt %, based on the total weight of Part A.

21. (canceled)

22. The adhesive of claim 1, wherein Part A comprises tetrahydrofurfuryl methacrylate, cyclohexyl methacrylate, and a divalent metal salt of methacrylic acid.

23-85. (canceled)
